(19) United States
(12) Patent Application Publication
(10) Pub. No.: US 2009/0297684 A1
(43) Pub. Date: Dec. 3, 2009

(54) Calcium-Enrichment Compositions and Methods for Production Thereof

(75) Inventors: Michael Paikin, Yoqneam (IL); Nissim Guigui, Misgav (IL); Maya Levy, Nahariya (IL)

Correspondence Address: THE NATH LAW GROUP, 112 South West Street, Alexandria, VA, 22314, US

(73) Assignee: Gadot Biochemical Industries Ltd, Haifa Bay (IL)

(21) Appl. No.: 12/223,330

(22) PCT Filed: Jan. 31, 2007
(86) PCT No.: PCT/IL2007/000119

§ 371 Date: Nov. 4, 2008

(30) Foreign Application Priority Data
Jan. 31, 2006 (IL) 173462

(51) Int. Cl. A23L 2/38; A23L 1/30

(52) U.S. Cl. 426/590; 426/648

(57) ABSTRACT

The invention discloses a calcium rich composition, as an aqueous composition or as a solid. The composition comprises a carbohydrate source, a calcium source and an edible organic acid. The composition may be used as calcium supplement (fortifier) in food, carbonated or non-carbonated beverages and concentrates.

### FIELD OF THE INVENTION

The invention is directed to soluble, stable compositions for calcium enrichment, methods for their production and their use as nutritional mineral supplements suitable for adding to food and beverage products.

### BACKGROUND OF THE INVENTION

Mineral and vitamin supplements are often used to fortify the composition of food and beverages, both for human and veterinary use. For example, U.S. Pat. No. 4,772,467 to Pak et al, discloses the use of citrate based calcium sources for increasing the bioavalability of the calcium. U.S. Pat. No. 4,786,518 to Nakel et al., describes nutritional supplements comprising iron-sugar complexes. U.S. Pat. No. 4,992,282 to Mehansho et al., describes stable nutritional vitamin and mineral supplemented beverages.

Iron supplements are commonly used in order to prevent anemia in the consumers. U.S. Pat. No. 4,786,510 discloses calcium-iron supplements, especially calcium citrate-malate and iron sugar complexes, which are used in a dry form.

Calcium supplements find wide applications as food and beverage supplements. They are used, inter alia, to compensate calcium loss from the human body, as is exhibited in osteoporosis. For example, U.S. Pat. No. 4,994,283 to Mehansho et al., discloses iron-calcium mineral supplements with enhanced bioavailability. U.S. Pat. No. 5,445,837 to Burkes et al., discloses as sweetener supplement fortified with a concentrated bioavailable calcium source and process for making them. U.S. Pat. No. 5,486,506 to Andon discloses a concentrated bioavailable calcium source. U.S. Pat. No. 6,828,130 to Chatterjee et al., discloses methods for production of gluconate salts. U.S. Pat. No. 6,887,897 to Walsdorf, Sr., et al. discloses calcium glutarate supplements and phosphorus binders.

### SUMMARY OF THE INVENTION

The present invention is directed to edible calcium comprising compositions that are stable in food and beverages as well as in food and beverages supplements. The calcium comprising compositions may be in a soluble form, being stable in beverages both carbonated and non-carbonated, or in their concentrates, and do not separate out of the liquid phase even under long storage periods. The calcium comprising composition of the present invention does not affect the organoleptic properties of the beverage or beverage concentrate to which it is introduced and thus serves as an effective calcium supplement (fortifier) for beverages and solid food. Concentrates comprising the supplements have a relatively low water activity which requires that the calcium source have a very high solubility.

Thus the present invention is directed to a calcium enriched composition comprising:

(i) at least one carbohydrate;

(ii) at least one source of calcium; and

(iii) at least one edible organic acid or salts thereof;

wherein the calcium contents is at least 5% (w/w) and has a water solubility of at least 500 g/L.

Preferably, the composition comprises of 30-60% (w/w) of at least one source of carbohydrates, 30-60% (w/w) of at least one source of an edible organic acid or salts thereof and 6-12% (w/w) of the at least one source of calcium. More preferably, the composition comprises of 40-55% (w/w) of at least one source of carbohydrates, 40-55% (w/w) of at least one source of an edible organic acid or salts thereof and 8-10% (w/w) of the at least one source of calcium The water solubility of the calcium enriched composition may even be as high as at least 700 g/L as STP.

The carbohydrate may be one or more of the group consisting of mono-, oligo- and polysaccharides, derivatives, salts thereof and their mixtures. The carbohydrate may be a simple carbohydrate such as aldoses, ketoses or cyclic carbohydrates or a complex carbohydrate composition such as molasses, corn steep liquor, preferably water soluble. More preferably, the simple carbohydrates are selected from C₅-C₇ sugars such as pentose, glucose, fructose, maltose, sucrose, galactose, lactose. Derivatives thereof are either naturally or synthetically derivatives, non limiting examples being ethers, esters, halogens.

The calcium source may be at least one calcium salt or ion, non limiting examples being calcium hydroxide, calcium oxide, calcium carbonate, calcium propionate, calcium gluconate, calcium stearate, calcium formate, calcium glycerophosphate, calcium phosphate-mon, di and tribasic.

The edible organic acid may be a straight, branched or cyclic (lactone) organic acid, its salt, anhydride or mixtures thereof. Non limiting examples are ascorbic acid, citric acid, malic acid, fumaric acid, lactic acid, gluconic acid.

The composition may further comprise stabilizers, coloring agents and emulsifiers. It may be in a dry form e.g. powder, granules, flakes, or in a wet form preferably as an aqueous solution.

Preferably, the calcium enriched composition of the present invention is an aqueous composition comprising 5-100% (w/w) of the carbohydrate-calcium-organic acid. Such a preferred composition may comprise: (i) glucose-calcium-gluconic acid; (ii) fructose-calcium-gluconic acid; (iii) a mixture of glucose:fructose-calcium-gluconic acid; (iv) glucose-calcium-gluconate.

The present invention is further directed to a method of producing a calcium enriched composition comprising:
(i) mixing at least one carbohydrate with at least one source of calcium in an aqueous solution to form a an aqueous suspension;
(ii) keeping the aqueous suspension under controlled temperature to optimize the yield; and
(iii) adding at least one edible organic acid to the suspension to form a calcium enriched aqueous composition.

The excess calcium in step (ii) separating out of the aqueous solution in step (ii), thus forming the suspension, may be removed prior to conducting step (iii). It should be understood that in order to obtain improved dissolution of the carbohydrate in the aqueous solution in step (i), the temperature should be higher than the temperature in step (ii) where the optimization of obtaining improved solubilization of the calcium requires lowering the temperature.

The method may comprise a further step of drying said aqueous composition to obtain edible calcium enriched dry composition.

The invention is further directed to foods, beverages or beverage concentrates comprising the calcium enriched composition.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a simplified flowchart illustrating a process for producing a mineral sugar acid product according to an embodiment of the present invention;

FIG. 2 is a simplified flowchart illustrating a process for supplementing a diluted vitamin syrup with a calcium sugar-acid product, produced in accordance with the process of FIG. 1; and

FIG. 3 is another simplified flowchart illustrating a process for supplementing vitamin syrup with a calcium sugar-acid product, produced in accordance with the process of FIG. 1.

### DETAILED DESCRIPTION OF EMBODIMENTS

The present invention relates to a stable composition of calcium source, preferably in the form of edible organic acid-calcium-carbohydrate, to methods for its preparation and its use as a calcium supplement in food, beverages and liquid concentrates. The composition may be used either directly for enhancing uptake of calcium or as an additive in various food and beverages to fortify these food products with calcium. The acid-calcium-carbohydrate may be a dry powder or a water soluble composition. It is stable in beverages and in food, to which it is added. It may be added to foods and beverages at various temperature ranges. Thus it can be added to hot food product or beverage, to a product being at ambient temperature or to chilled/frozed products.

The three components of the composition, namely, calcium, carbohydrate and edible organic acid, their salts and derivatives, typically form ions in solution and may or may not react/interact one with the other. Upon drying, these materials change their interactions and conformation.

Without being bound to any theory, the compositions of the present invention may comprise i) calcium bound to both a sugar ion and to an organic acid ion. There may also be ii) calcium bound to two sugar ions; and/or iii) calcium bound to two organic acid ions. There may also be an interaction between the sugar ion/molecule and the organic acid ion/molecule. Yet another possibility is a mixture of i), ii) and iii) and interactions therebetween upon physical and chemical processing in the methods of the present invention. However, regardless of the actual interactions between the carbohydrate(s), calcium source(s) and edible organic acid source(s), the properties of solubility and availability of the calcium are as described herein.

Without being bound to any theory, it is stipulated that, the unique chemical structure of calcium being bound to both a sugar and to an edible acid prevents the calcium from reacting with the food or beverage. In particular, the acid-calcium-carbohydrate may be added to beverages. Such beverages can be, but are not limited to, concentrated drinks and syrups, fruit juices, artificial juices, carbonated or non-carbonated beverages.

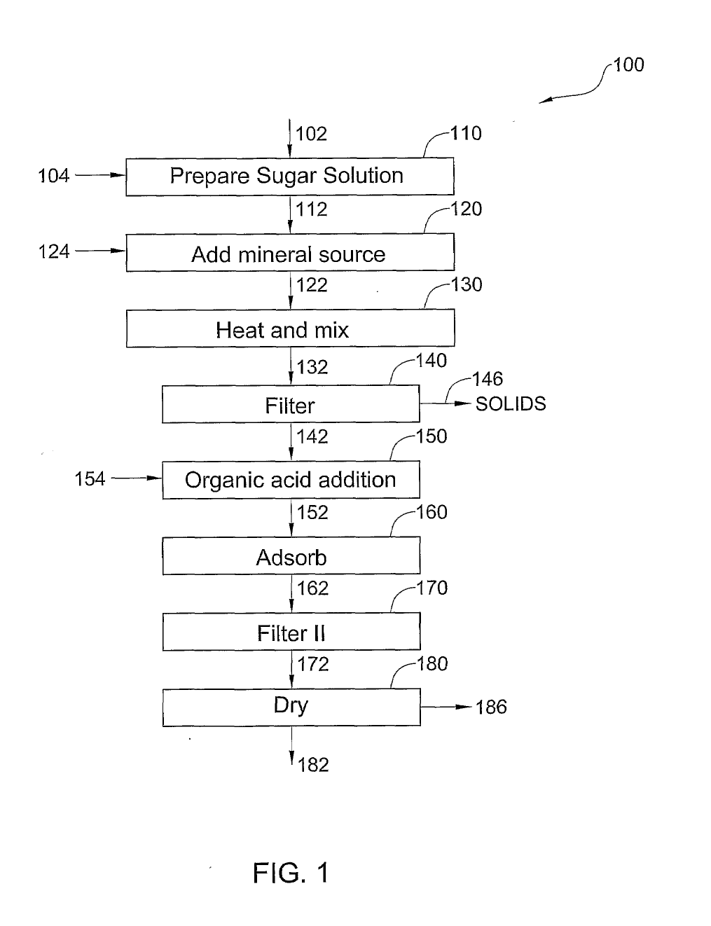

Reference is now made to FIG. 1, which is a simplified flowchart 100 illustrating a process for producing a mineral sugar acid product according to an embodiment of the present invention.

In a first sugar solution preparation step 110, a sugar 102 such as C₅-C₇ sugars such as pentose, glucose, fructose, maltose, sucrose, galactose, lactose or their mixtures is dissolved in an aqueous solution 104 to form a solution 112. In order to obtain improved concentrations of sugar in the aqueous solution, it may be heated to temperatures of about up to 80° C. In some embodiments, these monosaccharide and/or disaccharide sugars may be replaced by a polysaccharide, a carbohydrate or mixtures thereof. Alternatively, a mixed energy source may be employed comprising at least one sugar and at least one polysaccharide. In some other embodiments at least one sugar may be used with another soluble carbohydrate.

Turning to the calcium addition step 120, at least one calcium source 124 is added to the solution 112. The calcium source is typically selected from calcium hydroxide, calcium oxide, calcium carbonate, calcium propionate, calcium gluconate, calcium stearate, calcium formate, calcium glycerophosphate, calcium phosphate-mon, di and tribasic. The raw materials can be obtained commercially as follows: calcium oxide (Schaefer Kalk KG), glucose (Dextrose Monohydrate from Corn Products International, Inc.); gluconic acid (Jungbunzlauer AG). In an embodiment, the calcium source 124 is calcium oxide mixed with solution 112 to form suspension 122. The calcium source may not typically readily dissolve in water. The suspension is therefore mixed and kept in a mixing step 130 while maintaining the temperature (heating or cooling as required) to form a sugar-mineral solution 132.

In a filtration step 140, the sugar-mineral solution 132 is filtered over a filter so as to remove any sediments. Any kind of suitable equipment can be used for this operation, for example it can be decanter centrifuge, microfiltration or just simple filter. A filter aid may be employed, such as diatomite earth, cellulose or any other filter aid known in the art. The purpose of this step is to form a clear sugar-mineral solution 142.

In an organic acid addition step 150, at least one organic acid 154 is added to solution 142 to form a sugar-acid mineral solution 152. The at least one organic acid 154 is typically selected but not limited, from citric acid, malic acid, fumaric acid, lactic acid, gluconic acid, citric acid and mixtures thereof. In an embodiment the least one organic acid 154 is gluconic acid. The sugar-acid mineral solution 152 is then optionally decolorized in an adsorption step 160. In an embodiment, the sugar-acid mineral solution 152 is adsorbed on activated carbon to form a decolorized sugar-acid mineral solution 162.

In an optional filtration step 170, the solution 152 or 162 is filtered to form a filtered sugar-acid mineral solution 172.

Solution 172 may then be dried in a drying step 180 into a powder using a spray drying or freeze drying process known in the art. Excess liquid 186 is removed from the solution until a solid phase forms. The solid phase may be in the form of a powder, flakes, granules or other solid form. The resultant sugar-acid mineral powder 182 may then be suitably stored and/or packaged for use as a calcium source in food and beverages (not shown). In accordance with the present invention, the carbohydrate-organic acid-calcium powder 182 is a calcium glucose-gluconic acid powder, hereinafter “CGG”. “CGG” is used broadly herein to refer to any mix of calcium, glucose and gluconic acid in any chemical combination or combinations resultant from the process of FIG. 1.

It should be understood that various changes could be made to the process of FIG. 1. For example, one could first add an organic acid to water, thereafter add the mineral source and heat the resultant slurry to form a calcium organic acid solution. Thereafter the sugar source could be added to the calcium organic acid solution. Numerous other permutations and variations to FIG. 1 are envisaged, which form an integral part of the present invention.

The properties of the CGG powder produced by the process of FIG. 1 are shown in Table 1.

TABLE 1
Typical Properties of Calcium Glucose-Gluconate Powder

| PROPERTY | CGG POWDER |
|---|---|
| APPEARANCE: | Off white powder |
| ODOR: | Odorless |
| SOLUBILITY: IN WATER | Not less than 50% |
| PH OF 1% SOLUTION | from 6 to 8 |
| ASSAY OF Ca (ON A DRY BASIS) | from 7 to 12% |

The resultant CGG powder is a calcium-rich highly soluble powder, which can be added to liquid dietary food supplements and vitamins as given in the following examples.

### EXAMPLES

All sugars, organic acids and mineral salts described herein, if not stated explicitly, are available from Sigma Aldrich Corporation, St. Louis, Mo., USA.

### Example 1

720 g glucose (D-glucose, Sigma catalog no. G7528, Sigma Aldrich Corporation, St. Louis, Mo., USA) was dissolved in 4.8 L deionized water (D.I.) and was mixed by a magnetic stirrer or upper mechanical agitator (agitator —RZR1 from Heidolph Instruments GMBH & CO KG). The resultant solution was gently heated at temperatures of up to 80° C. and stirred for 10-30 minutes so as to fully dissolve the sugar.

### Example 2

Preparation of 336 g of CaO was mixed with solution 112 (FIG. 1) to form a suspension 122. This step proceeded for several hours at a temperature between 60° C. to 80° C. Thereafter, a filtration step is performed in which excess calcium is filtered or centrifuged off. This step may be similar to or different from step 140 described hereinabove with reference to FIG. 1.

### Example 3

Gluconic acid (Sigma Catalog No. G1139 Sigma Aldrich Corporation, St. Louis, Mo., USA) was added under pH control until the pH of the solution was 6.2-6.5, where about 1784 g of gluconic acid was added to the calcium oxide glucose solution of Example 2 to form a calcium glucose-gluconic acid solution. The resultant solution was further processed as is described in steps 160-180 of FIG. 1.

### Example 4

### Fortifying a Diluted Vitamin Syrup

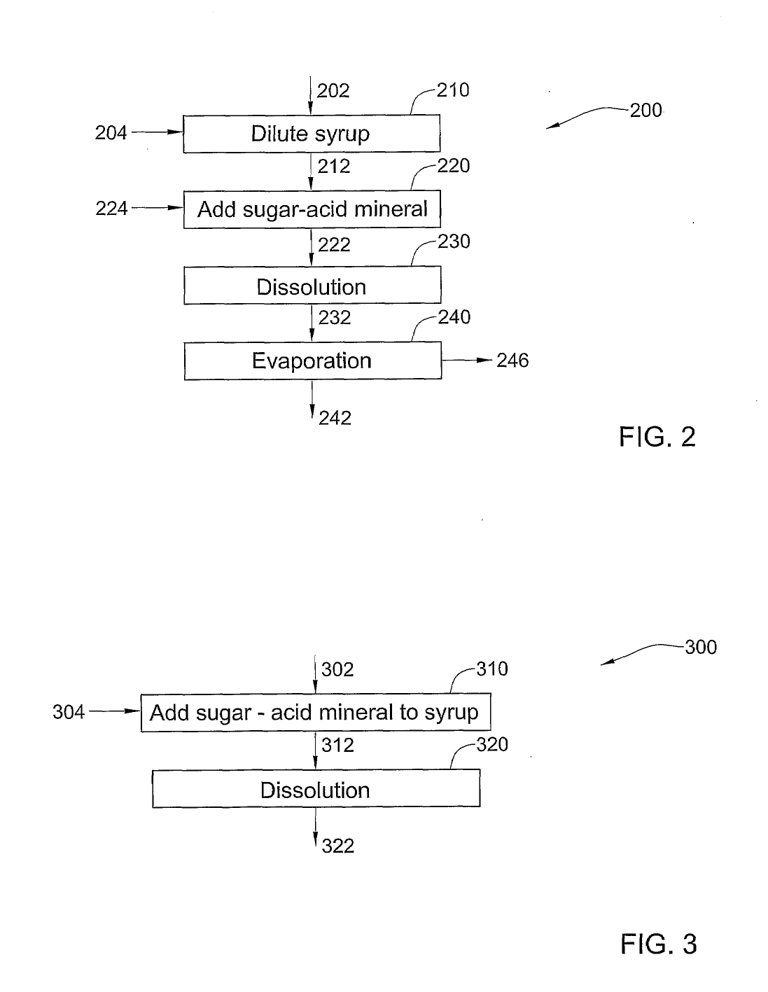

Fortification of the diluted vitamin syrup with a calcium sugar-gluconate product was carried out as is described herein below with respect to FIG. 2 and FIG. 3.

Reference is now made to FIG. 2, which is a simplified flowchart 200 illustrating a process for supplementing diluted vitamin. syrup with a calcium sugar-gluconate product, produced in accordance with the process of FIG. 1.

Vitamin syrup 202, such as syrup containing fruit concentrate, preservatives, fructose, vitamin supplements, as sold under the trademark VITAMINCHIK™ (Beit—Hashita Assis Food Industries RA, Israel) was diluted in a dilution step 210 with water 204, preferably deionized water to form dilute syrup 212. The ratio of syrup to water varied and was in the range between 1:10 to 1:2, more preferably 1:7 to 1:4. The most common dilution ration was 1:6.

In an additional step 220, a sugar-acid mineral 224, such as CGG was added to the dilute syrup. Typically, 3 to 5 g of CGG were added per liter of dilute syrup to form a slurry 222, yielding an enrichment level of about 400 mg calcium/per 250 ml of final drink in the final drink.

In a dissolution step 230, the slurry was heated and mixed until all the solids were dissolved. This was performed employing any agitated vessel, equipped with a temperature control system, known in the art, such that calcium-supplemented dilute syrup 232 forms.

In the evaporation step 240, the calcium-supplemented dilute syrup 232 was heated to remove the water added in step 210 so as to produce a calcium-supplemented vitamin syrup 242 such as “calcium-supplemented VITAMINCHIK™. This step can be performed in any suitable apparatus, such as Thin Layer Evaporation unit “Rotovapor R-124” (BÜCHI Labortechnic AG, Postfach CH 9230 Switzerland).

TABLE 2
Comparison of properties of vitamin syrup and
calcium-supplemented vitamin syrup of FIG. 2.

| | | | CALCIUM | |
|---|---|---|---|---|
| | VITAMINCHIK ™ | | SUPPLEMENTED | |
| PROPERTIES | SYRUP | | VITAMINCHIK (242) | |
| SOLIDS | 65-67 | Bx | 65.7 | Bx |
| CONCENTRATION | | | | |
| VISCOSITY | about 150 | cp | 814 | cp |

### Example 5

Reference is now made to FIG. 3, which is another simplified flowchart 300 illustrating a process for supplementing vitamin syrup with a calcium sugar-gluconate product, produced in accordance with the process of FIG. 1.

In an addition step 310, a quantity of 20-30 g of calcium sugar-gluconate 304 were added to undiluted syrup 302, such as VITAMINCHIK™ to form a syrup slurry 312. In a dissolution step 320, the slurry was mixed for several hours until the solids disappeared and a calcium supplemented syrup 322 forms. This step may be performed employing any kind of agitated vessel, known in the art. It should be noted that the syrup 322 may optionally be degassed by employing ultrasonic energy to the syrup, employing for example Ultrasonic base type USR 6/3, Julabo USA, Inc. (Allentown, Pa., USA).

The properties of the fortified syrup 322 appear in Table 3.

TABLE 3
Comparison of properties of vitamin syrup and
calcium-supplemented vitamin syrup of FIG. 3.

| | | | CALCIUM | |
|---|---|---|---|---|
| | VITAMINCHIK ™ | | SUPPLEMENTED | |
| PROPERTIES | SYRUP | | VITAMINCHIK (322) | |
| SOLIDS | 65-67 | Bx | 71.2 | Bx |
| CONCENTRATION | | | | |
| VISCOSITY | about 150 | cp | 410 | cp |

### Example 6

The process of FIG. 3 was also applied to a “YACHIN” syrup (Strawberry Syrup, produced by Zanlecol, POB 2445, Afula, Israel). In brief, 24 g of CGG were mixed with 1000 g of YACHIN syrup. The properties of the resultant calcium-rich syrup are presented in Table 4.

TABLE 4
Comparison of properties of YACHIN vitamin syrup
and calcium-supplemented vitamin YACHIN syrup.

| | | | CALCIUM | |
|---|---|---|---|---|
| | “YACHIN” | | SUPPLEMENTED YACHIN | |
| PROPERTIES | SYRUP | | SYRUP | |
| SOLIDS | 68.4 | BX | 74.2 | BX |
| CONCENTRATION | | | | |
| VISCOSITY | 156 | cp | 500 | cp |

### Example 7

A process was carried out as described in example 1 above, using 360 g glucose and 360 g fructose as the sugar source (glucose:fructose ratio 1:1). The product obtained had substantially the same properties as those of the product in Table 1.

### Example 8

The same components described in Example 1 above were used and the process was carried out as in FIG. 1. Following the adsorption step 160, an additional evaporation step was introduced, in which 50% of the water in solution was evaporated (Thin Layer Evaporation unit “Rotovapor R-124”, BÜCHI Labortechnik AG, Postfach CH-9230 Switzerland). The product obtained had substantially the same properties as those of the product in Table 1.

### Example 9

A process was carried out as described in example 1 above using 108 g glucose and 612 g fructose as the sugar source (glucose:fructose ratio 15:85). The product obtained had substantially the same properties as those of the product in Table 1.

### Example 10

A process was carried out as in example 1, using 612 g glucose and 108 g fructose as a sugar source (glucose:fructose ratio 85:15). The product obtained had substantially the same properties as those of the product in Table 1.

### Example 11

Solubility test: 100 g of CGG powder 182 (FIG. 1) were added to 100 ml Deionized water while stirred at ambient temperature and pressure. After 1 hour retention the dissolution was completed and clear solution obtained. This showed that the CGG of the present invention has a solubility of 1000 g/l.

### Example 12

A process was carried out as described in example 1 above, using 612 g Raftilose P95 as the sugar source (ORAFTI Active Food Ingredients, Tienen, Belgium). The product obtained had substantially the same properties as those of the product in Table 1.

### Example 13

A process was carried out as described in example 1 above using 612 g Fibrulose F97 as the sugar source (Cosucra SA, Warcoing, Belgium). The product obtained had substantially the same properties as those of the product in Table 1.

### Example 14

A process was carried out as described in example 3 above using Glucono-delta-lactone (Sigma Catalog No. G4750 Sigma Aldrich Corporation, St. Louis, Mo., USA) as the sugar source. The product obtained had substantially the same properties as those of the product in Table 1.

### Example 15

In this example, the process was carried out as described hereinabove for example 4, but the beverage for calcium fortification that was used was a carbonated beverage (RC Cola®, Royal Crown Cola International®, Georgia USA). There were no significant changes in organoleptic properties of beverage following the addition of 30% RDA/liter (about 300 to about 350 mg).

1. A calcium enriched composition comprising:
(i) at least one carbohydrate;
(ii) at least one source of calcium; and
(iii) at least one edible organic acid or salts thereof
wherein the calcium contents is at least 5% (w/w) and has a water solubility of at least 500 g/L.

2. A composition according to claim 1, wherein the carbohydrate is selected from the group consisting of mono-, oligo- and polysaccharides, derivatives or salts thereof and their mixtures.

3. A composition according to claim 2 wherein the carbohydrate is selected from pentose, glucose, fructose, maltose, sucrose, galactose, lactose, molasses, corn steep liquor.

4. A composition according to claim 2 wherein said derivatives thereof are naturally or synthetically derivatives selected from ethers, esters or halogens.

5. A composition according to claim 1, wherein the calcium is calcium salt or ion selected from the group consisting of calcium hydroxide, calcium oxide, calcium carbonate, propionate, calcium gluconate, calcium stearate, calcium formate, calcium glycerophosphate, calcium phosphate-mon-, di- and tribasic.

6. A composition according to claim 1, wherein the edible organic acid is a straight, branched or cyclic (lactone) organic acid, anhydrides, salts or mixtures thereof.

7. A composition according to claim 6 wherein said edible organic acid is selected from the group consisting of ascorbic acid, citric acid, fumaric acid, gluconic acid, lactic acid, malic acid or tartaric acid.

8. A composition according to any one of claim 1 wherein the amount of the at least one source of carbohydrate is 30-60% (w/w), the amount of the at least one source of an edible organic acid is 30-60% (w/w) and the amount of the at least one source of calcium is 6-12% (w/w).

9. A composition according to claim 8 wherein the amount of the at least one source of carbohydrate is 40-55% (w/w), the amount of the at least one source of an edible organic acid is 40-55% (w/w) and the amount of the at least one source of calcium is 8-10% (w/w)

10. A calcium enriched composition of claim 1 further comprising at least one additive selected from coloring agent, stabilizer or an emulsifier.

11. A composition according to claim 1, wherein the composition has solubility in water of at least 700 g/L at STP.

12. A composition according to claim 1 comprising calcium, a carbohydrate source selected from glucose, fructose or their mixtures and gluconic acid or its salt.

13. A composition according to claim 12 comprising glucose-calcium-gluconate.

14. A composition according to claim 13, being 5% to 100% by weight.

15. Food, carbonated or non-carbonated beverage, or concentrates thereof fortified with a composition according to claim 1.

16. A method for producing an aqueous calcium-rich composition, comprising:
(i) mixing at least one carbohydrate with at least one source of calcium in an aqueous solution to form an aqueous suspension;
(ii) keeping the aqueous suspension under controlled temperature to optimize yield; and
(iii) adding at least one edible organic acid to the solution to form a calcium enriched aqueous composition having a solubility of at least 500 gr/L.

17. A method according to claim 16 further comprising the step of removing excess calcium after step (ii).

18. (canceled)

19. A method according to claim 16 further comprising:
(iv) drying the calcium enriched aqueous composition to form a dry calcium enriched composition.

20. A calcium-rich dry composition obtained in accordance with claim 19 in the form of powder, granules or flakes.
